(19) United States
(12) Patent Application Publication
(10) Pub. No.: US 2021/0166679 A1
(43) Pub. Date: Jun. 3, 2021

(54) SELF-TRAINING DATA SELECTION APPARATUS, ESTIMATION MODEL LEARNING APPARATUS, SELF-TRAINING DATA SELECTION METHOD, ESTIMATION MODEL LEARNING METHOD, AND PROGRAM

(71) Applicant: NIPPON TELEGRAPH AND TELEPHONE CORPORATION, Tokyo (JP)

(72) Inventors: Atsushi ANDO, Kanagawa (JP); Hosana KAMIYAMA, Kanagawa (JP); Satoshi KOBASHIKAWA, Kanagawa (JP)

(73) Assignee: NIPPON TELEGRAPH AND TELEPHONE CORPORATION, Tokyo (JP)

(21) Appl. No.: 17/048,041

(22) PCT Filed: Mar. 28, 2019
(86) PCT No.: PCT/JP2019/013689

§ 371 Date: Oct. 15, 2020

(30) Foreign Application Priority Data
Apr. 18, 2018 (JP) 2018-080044

(51) Int. Cl. G10L 15/14; G10L 15/18; G10L 25/30

(52) U.S. Cl. CPC G10L 15/14; G10L 25/30; G10L 15/1807

(57) ABSTRACT

An estimation model is self-trained by utilizing a large amount of utterance with no teacher label. An estimation model learning part (11) learns an estimation model for estimating confidence for each of predetermined labels from each of feature amounts extracted from input data using a plurality of the independent feature amounts extracted from utterance with a teacher label. A paralinguistic information estimating part (12) estimates confidence for each of the labels from feature amounts extracted from utterance with no teacher label using the estimation model. When confidence for each label obtained from the utterance with no teacher label exceeds all confidence thresholds which are set in advance for each of the feature amounts for the feature amount to be learned, a data selecting part (13) adds a label corresponding to the confidence to data with no teacher label as a teacher label to select the data as self-training data. An estimation model relearning part (14) relearns the estimation model using the self-training data.

### TECHNICAL FIELD

The present invention relates to a technique of learning an estimation model for performing label classification using a plurality of independent feature amounts.

### BACKGROUND ART

There is a need for a technique of estimating paralinguistic information (for example, whether utterance intention is interrogative or declarative) from speech. The paralinguistic information can be applied to, for example, sophistication of speech translation (it is possible to translate Japanese into English while intention of an utterer is correctly understood even for frank utterance, for example, Japanese utterance “Ashita” is understood to have interrogative intention such as “Ashita?” and translated into English as “Is it tomorrow?”, or understood to have declarative intention such as “Ashita” and translated into English as “It is tomorrow.”), or the like.

As an example of the technique of estimating paralinguistic information from speech, a technique of estimating interrogation from speech is disclosed in Non-patent literatures 1 and 2. In Non-patent literature 1, whether utterance is interrogative or declarative is estimated on the basis of time-series information of prosodic features such as voice pitch for each short period of speech. In Non-patent literature 2, it is estimated whether utterance is interrogative or declarative based on linguistic features (which word is appeared) in addition to utterance statistic (such as an average and dispersion) of prosodic features. In either technique, a paralinguistic information estimation model is learned using a machine learning technique such as deep learning from a set of feature amounts and a teacher label (a correct value of the paralinguistic information, for example, a binary of interrogative and declarative) for each piece of utterance, and the paralinguistic information of utterance which is to be estimated is estimated on the basis of the paralinguistic information estimation model.

In these related arts, a model is learned from a few pieces of utterance to which teacher labels are provided. This is because a teacher label of the paralinguistic information is required to be provided by a human, and it requires cost to collect utterance to which teacher labels are provided. However, in a case where there are a few pieces of utterance for model learning, features of the paralinguistic information (such as, for example, a prosodic pattern peculiar to interrogative utterance) cannot be correctly learned, and there is a possibility that estimation accuracy of the paralinguistic information may degrade. Therefore, a large amount of utterance to which teacher labels are not provided, as well as a few pieces of utterance to which teacher labels (not limited to a binary, but may be multiple values) are provided, are utilized. Such a learning method is called semi-supervised learning.

Examples of a typical semi-supervised learning method can include self-training (see Non-patent literature 3). Self-training is a method in which a label of unsupervised data is estimated using an estimation model learned from a few pieces of data with teacher labels, and the estimated label is relearned as a teacher label. At this time, only utterance with high confidence of the teacher label (such as, for example, utterance for which a posterior probability of a certain teacher label is equal to or higher than 90%) is learned.

### PRIOR ART LITERATURE

### Non-Patent Literature

Non-patent literature 1: Y. Tang, Y. Huang, Z. Wu, H. Meng, M. Xu, L. Cai, “Question detection from acoustic features using recurrent neural network with gated recurrent unit, “Proc. ICASSP, pp. 6125-6129, 2016
Non-patent literature 2: K. Boakye, B. Favre, D. Hakkini-Tur, “Any Questions? Automatic Question Detection in Meetings,” Proc. ASRU, pp. 485-489, 2009
Non-patent literature 3: D. Yarowsky, “Unsupervised word sense disambiguation rivaling supervised methods, “Proc. ACL, pp. 189-196, 1995

### SUMMARY OF THE INVENTION

### Problems to be Solved by the Invention

However, it is difficult to improve estimation accuracy even if self-training is simply introduced into learning of a paralinguistic information estimation model, because a teacher label of paralinguistic information is determined on the basis of complicated factors. For example, as illustrated in FIG. 1, whether utterance has interrogative intention is indicated with the same teacher label of “interrogative” both in a case where only one of prosodic features (whether tone of voice is interrogative) and linguistic features (whether utterance is interrogative as a sentence) indicates features of interrogative intention, and in a case where both of the features indicate features of interrogative intention. In a case where self-training is performed on such complicated utterance, complexity is not correctly learned with the estimation model learned from a few pieces of utterance with teacher labels, and an estimation error of confidence is likely to occur. That is, cases where utterance which should not be learned is self-trained increase, which makes it difficult to improve estimation accuracy through self-training.

In view of such technical problems, an object of the present invention is to effectively self-train an estimation model by utilizing a large amount of data with no teacher label.

### Means to Solve the Problems

To solve the above-described problems, a self-training data selection apparatus according to a first aspect of the present invention includes an estimation model storage configured to store an estimation model for estimating confidence for each of predetermined labels from each of feature amounts extracted from input data, learned using a plurality of the independent feature amounts extracted from data with a teacher label, a confidence estimating part configured to estimate confidence for each of the labels from the feature amounts extracted from data with no teacher label using the estimation model, and a data selecting part configured to, when one feature amount selected from the feature amounts is set as a feature amount to be learned, the confidence for each label obtained from the data with no teacher label exceeds all confidence thresholds which are set in advance for each of the feature amounts for the feature amount to be learned, and labels for which confidence exceeds the confidence thresholds are the same in all feature amounts, add a label corresponding to the confidence which exceeds all the confidence thresholds to the data with no teacher label as a teacher label to select the data as self-training data of the feature amount to be learned, and the confidence thresholds are set higher for a feature amount which is not to be learned than for the feature amount to be learned.

To solve the above-described problems, an estimation model learning apparatus according to a second aspect of the present invention includes an estimation model storage configured to store an estimation model for estimating confidence for each of predetermined labels from each of feature amounts extracted from input data, learned using a plurality of the independent feature amounts extracted from data with a teacher label, a confidence estimating part configured to estimate confidence for each of the labels using the estimation model from the feature amounts extracted from data with no teacher label, a data selecting part configured to, when one feature amount selected from the feature amounts is set as a feature amount to be learned, the confidence for each label obtained from the data with no teacher label exceeds all confidence thresholds which are set in advance for each of the feature amounts for the feature amount to be learned, and labels for which confidence exceeds the confidence thresholds are the same in all feature amounts, add the a label corresponding to the confidence which exceeds all the confidence thresholds to the data with no teacher label as a teacher label to select the data as self-training data of the feature amount to be learned, and an estimation model relearning part configured to relearn the estimation model corresponding to the feature amount to be learned using the self-training data of the feature amount to be learned, and the confidence thresholds are set higher for a feature amount which is not to be learned than the feature amount to be learned.

### Effects of the Invention

According to the present invention, it is possible to effectively self-train an estimation model by utilizing a large amount of data with no teacher label. As a result, estimation accuracy of an estimation model for estimating paralinguistic information from speech is improved.

### BRIEF DESCRIPTION OF THE DRAWINGS

FIG. 1 is a diagram for explaining relationship between prosodic features and linguistic features, and paralinguistic information;

FIG. 2 is a diagram for explaining a difference in data selection between the present invention and related art;

FIG. 3 is a diagram illustrating a functional configuration of an estimation model learning apparatus;

FIG. 4 is a diagram illustrating a functional configuration of an estimation model learning part;

FIG. 5 is a diagram illustrating a functional configuration of a paralinguistic information estimating part;

FIG. 6 is a diagram illustrating processing procedure of an estimation model learning method;

FIG. 7 is a diagram illustrating a self-training data selection rule;

FIG. 8 is a diagram illustrating a functional configuration of a paralinguistic information estimation apparatus;

FIG. 9 is a diagram illustrating processing procedure of a paralinguistic information estimation method;

FIG. 10 is a diagram illustrating a functional configuration of the estimation model learning apparatus;

FIG. 11 is a diagram illustrating processing procedure of the estimation model learning method;

FIG. 12 is a diagram illustrating a functional configuration of the estimation model learning apparatus; and

FIG. 13 is a diagram illustrating processing procedure of the estimation model learning method.

### DETAILED DESCRIPTION OF THE EMBODIMENTS

Embodiments of the present invention will be described in detail below. Note that the same reference numerals will be assigned to components having the same functions in the drawings, and overlapped description will be omitted.

The point of the present invention is to select “utterance which should be surely learned” while characteristics of paralinguistic information are taken into account. As described above, the problem of self-training is that there is a possibility that utterance which should not be learned may be utilized for self-training. Therefore, if the “utterance which should be surely learned” is detected, and only the utterance is utilized for self-training, it is possible to solve this problem.

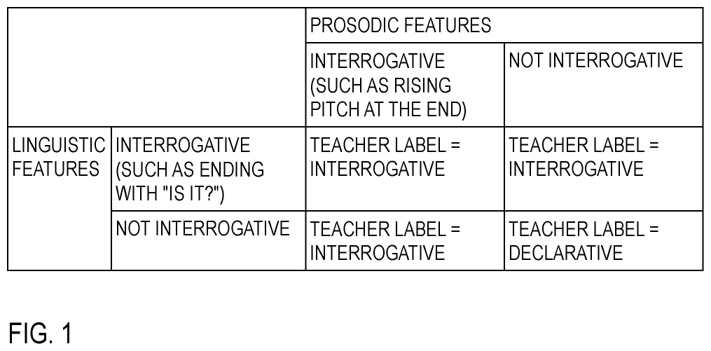

Characteristics of the paralinguistic information are utilized for detection of the utterance which should be learned. As illustrated in FIG. 1, as the characteristics of the paralinguistic information, it can be exemplified that estimation is possible by only one of prosodic features and linguistic features. By utilizing this, in the present invention, model learning is respectively performed with the prosodic features and the linguistic features, and only utterance with high confidence both in an estimation model of the prosodic features and in an estimation model of the linguistic features (in FIG. 1, a set of utterance with high confidence of “interrogative” both in the prosodic features and in the linguistic features, or with high confidence of “not interrogative” in the both features) is utilized for self-training If information can be estimated by only one of the prosodic features and the linguistic features as in the paralinguistic information, it is possible to select utterance which should be learned more accurately through such data selection from two aspects.

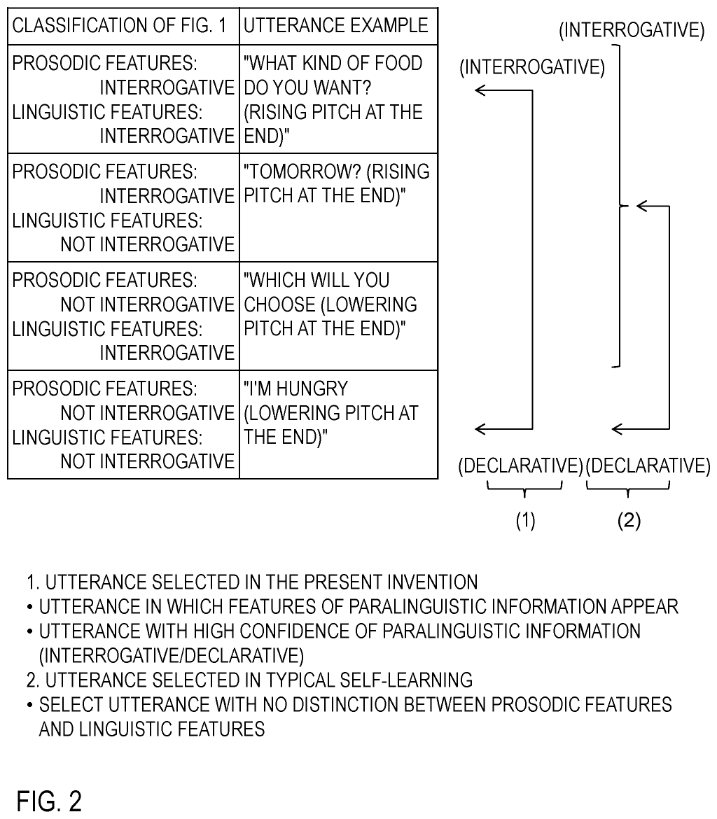

A specific example will be illustrated in FIG. 2. In a typical self-training method, utterance to be utilized for self-training is selected without distinction between the prosodic features and the linguistic features. In the present invention, only utterance with high confidence both in the prosodic features and in the linguistic features (for example, utterance at the top with high confidence of interrogative in both features, and utterance at the bottom with high confidence of declarative in both features) is selected and utilized for self-training. Further, in self-training, the estimation model based on only the prosodic features and the estimation model based on only the linguistic features are separately self-trained. By this means, with the estimation model based on only the prosodic features, features such as rising pitch at the end can be learned, and with the estimation model based on only the linguistic features, features such as an interrogative word (for example, “which”, “how”) can be learned. In estimation of the paralinguistic information, by performing final estimation on the basis of estimation results of an estimation model based on only the prosodic features and an estimation model based on only the linguistic features (for example, by estimating utterance as interrogative in a case where the utterance is determined as interrogative with one of the estimation models, and estimating utterance as declarative in a case where the utterance is not determined as interrogative with both the estimation models), it is possible to perform estimation with high accuracy even for utterance in which only one of the prosodic features and the linguistic features indicate features of the paralinguistic information.

Further, the present invention is characterized in that different confidence thresholds are respectively used in self-training of the estimation model based on only the prosodic features and self-training of the estimation model based on only the linguistic features. Typically, in self-training, if utterance with high confidence is utilized, an estimation model specialized for only utterance utilized for self-training is generated, and estimation accuracy is less likely to be improved. Meanwhile, if utterance with low confidence is utilized, while a variety of utterance can be learned, a possibility that utterance for which confidence is erroneously estimated (utterance which should not be learned) may be utilized for learning increases. In the present invention, a confidence threshold is set lower for features which are the same as features of a target of self-training, and a confidence threshold is set higher for features different from the features of the target of self-training (for example, when the estimation model based on only the prosodic features is self-trained, utterance with confidence of equal to or higher than 0.5 in an estimation result with the estimation model based on only the prosodic features and with confidence of equal to or higher than 0.8 in an estimation result with the estimation model based on only the linguistic features is utilized, while, when the estimation model based on only the linguistic features is self-trained, utterance with confidence of equal to or higher than 0.8 in an estimation result with the estimation model based on only the prosodic features and with confidence of equal to or higher than 0.5 in an estimation result with the estimation model based on only the linguistic features is utilized). By this means, it is possible to use a variety of utterance in self-training while excluding utterance for which confidence is erroneously estimated.

Specifically, the estimation model is self-trained through the following procedure.

Procedure 1: A paralinguistic information estimation model is learned from a few pieces of utterance to which teacher labels are provided. At this time, two estimation models of the estimation model based on only the prosodic features and the estimation model based on only the linguistic features are separately learned.

Procedure 2: Utterance which should be learned is selected from a number of pieces of utterance to which teacher labels are not provided. The selection method is as follows. Paralinguistic information of utterance to which a teacher label is not provided is estimated along with confidence using respective estimation models of the estimation model based on only the prosodic features and the estimation model based on only the linguistic features. Among utterance for which confidence based on one of the features is equal to or higher than a certain degree, utterance for which confidence based on the other features is equal to or higher than a certain degree is regarded as utterance which should be learned. For example, among utterance for which confidence is equal to or higher than a certain degree with the estimation model based on only the prosodic features, only utterance for which confidence is equal to or higher than a certain degree also with the estimation model based on only the linguistic features and which has the same paralinguistic information label of the estimation results is regarded as utterance which should be learned with the estimation model based on only the prosodic features. At this time, the confidence threshold is set lower for features which are the same as features of a target of model learning and is set higher for features which are different from the features of the target of model learning. For example, when the estimation model based on only the prosodic features is learned, the confidence threshold for the estimation model based on only the prosodic features is set lower, and the confidence threshold for the estimation model based on only the linguistic features is set higher.

Procedure 3: The estimation model based on only the prosodic features and the estimation model based on only the linguistic features are learned again using the selected utterance. As a teacher label at this time, a result of the paralinguistic information estimated in procedure 2 is utilized.

### First Embodiment

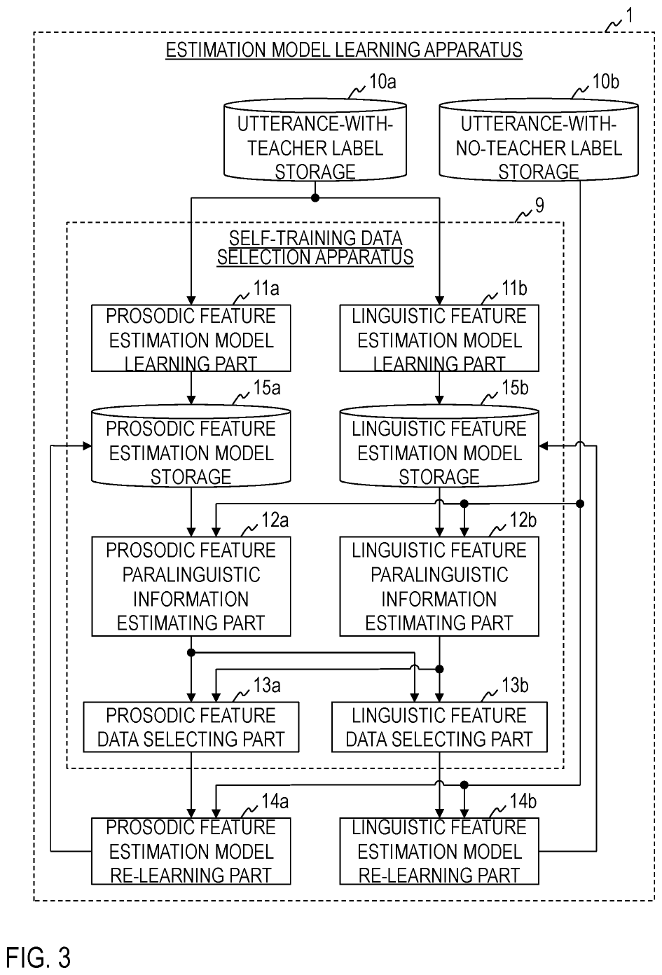

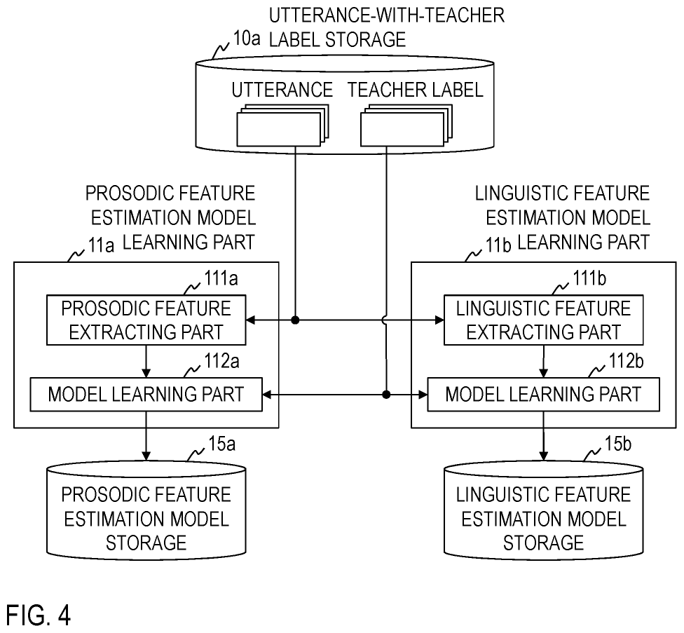

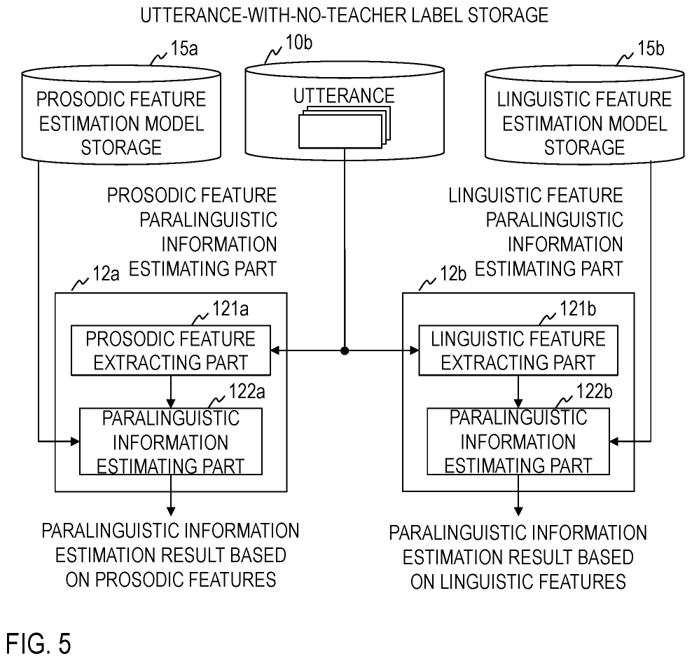

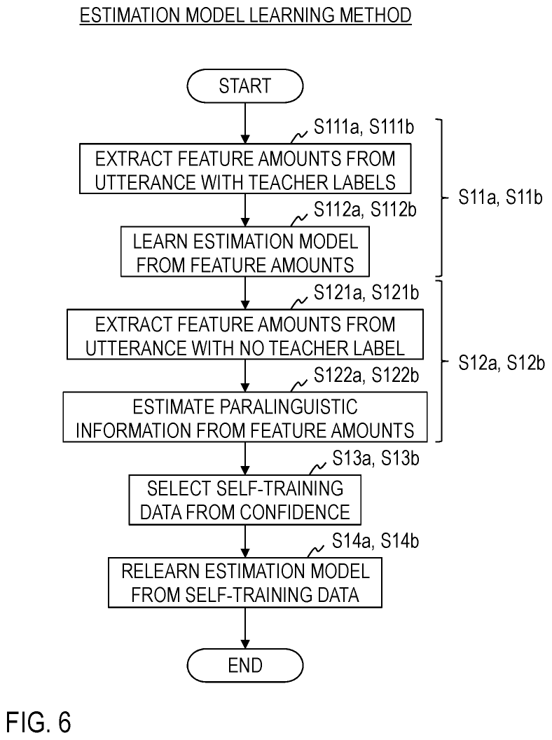

An estimation model learning apparatus 1 of a first embodiment includes, as illustrated in FIG. 3, an utterance-with-teacher label storage 10a, an utterance-with-no-teacher label storage 10b, a prosodic feature estimation model learning part 11a, a linguistic feature estimation model learning part 11b, a prosodic feature paralinguistic information estimating part 12a, a linguistic feature paralinguistic information estimating part 12b, a prosodic feature data selecting part 13a, a linguistic feature data selecting part 13b, a prosodic feature estimation model relearning part 14a, a linguistic feature estimation model relearning part 14b, a prosodic feature estimation model storage 15a, and a linguistic feature estimation model storage 15b. Among respective processing parts provided at the estimation model learning apparatus 1, the prosodic feature estimation model learning part 11a, the linguistic feature estimation model learning part 11b, the prosodic feature paralinguistic information estimating part 12a, the linguistic feature paralinguistic information estimating part 12b, the prosodic feature data selecting part 13a, the linguistic feature data selecting part 13b, the prosodic feature estimation model storage 15a, and the linguistic feature estimation model storage 15b can constitute a self-training data selection apparatus 9. As illustrated in FIG. 4, the prosodic feature estimation model learning part 11a includes a prosodic feature extracting part 111a and a model learning part 112a. In a similar manner, the linguistic feature estimation model learning part 11b includes a linguistic feature extracting part 111b and a model learning part 112b. As illustrated in FIG. 5, the prosodic feature paralinguistic information estimating part 12a includes a prosodic feature extracting part 121a and a paralinguistic information estimating part 122a. In a similar manner, the linguistic feature paralinguistic information estimating part 12b includes a linguistic feature extracting part 121b and a paralinguistic information estimating part 122b. By this estimation model learning apparatus 1 performing processing in respective steps illustrated in FIG. 6, an estimation model learning method of the first embodiment is realized.

The estimation model learning apparatus 1 is, for example, a special apparatus configured by a special program being loaded into a publicly known or dedicated computer including a central processing unit (CPU), a main storage apparatus (RAM: Random Access Memory), or the like. The estimation model learning apparatus 1, for example, executes respective kinds of processing under control by the central processing unit. Data input to the estimation model learning apparatus 1 and data obtained through the respective kinds of processing are, for example, stored in the main storage apparatus, and the data stored in the main storage apparatus is read out to the central processing unit as necessary and utilized for other processing. At least part of the respective processing parts of the estimation model learning apparatus 1 may be configured with hardware such as an integrated circuit. Respective storages provided at the estimation model learning apparatus 1 can be configured with, for example, a main storage apparatus such as a RAM (Random Access Memory), an auxiliary storage apparatus configured with a semiconductor memory device such as a hard disk, an optical disk and a flash memory, or middleware such as a relational database and a key-value store.

The estimation model learning method to be executed by the estimation model learning apparatus 1 of the first embodiment will be described below with reference to FIG. 6.

In the utterance-with-teacher label storage 10a, a few pieces of utterance with teacher labels are stored. The utterance with a teacher label is data in which speech data (hereinafter, simply referred to as “utterance”) obtained by collecting utterance of a human is associated with a teacher label of paralinguistic information for classifying the utterance. In the present embodiment, while the teacher label is set at a binary (interrogative, declarative), the teacher label may be multiple values of three or more values. The teacher label may be manually provided to utterance, or the teacher label may be provided to utterance using a known label classification technique.

In the utterance-with-no-teacher label storage 10b, a large amount of utterance with no teacher label is stored. The utterance with no teacher label is speech data obtained by collecting utterance of a human, and utterance to which a teacher label of paralinguistic information is not provided.

In step S11a, the prosodic feature estimation model learning part 11a learns a prosodic feature estimation model for estimating paralinguistic information on the basis of only the prosodic features, using the utterance with teacher labels stored in the utterance-with-teacher label storage 10a. The prosodic feature estimation model learning part 11a stores the learned prosodic feature estimation model in the prosodic feature estimation model storage 15a. The prosodic feature estimation model learning part 11a learns the prosodic feature estimation model as follows using the prosodic feature extracting part 111a and the model learning part 112a.

In step S111a, the prosodic feature extracting part 111a extracts prosodic features from the utterance stored in the utterance-with-teacher label storage 10a. The prosodic features are, for example, vectors including one or more feature amounts of a fundamental frequency, short-period power, Mel frequency Cepstral Coefficients (MFCC), zero-crossing, a Harmonics-to-Noise-Ratio (HNR), and Mel filter bank output. Further, the prosodic features may be time-series values of these for each period (for each frame) or may be statistic (such as an average, dispersion, a maximum value, a minimum value and a gradient) of these in the whole utterance. The prosodic feature extracting part 111a outputs the extracted prosodic features to the model learning part 112a.

In step S112a, the model learning part 112a learns the prosodic feature estimation model for estimating the paralinguistic information from the prosodic features on the basis of the prosodic features output from the prosodic feature extracting part 111a and the teacher labels stored in the utterance-with-teacher label storage 10a. The estimation model may be, for example, a deep neural network (DNN) or may be support vector machine (SVM). Further, in a case where a time-series value for each period is used as a feature vector, a time-series estimation model such as a long short-term memory recurrent neural networks (LSTM-RNNs) may be used. The model learning part 112a stores the learned prosodic feature estimation model in the prosodic feature estimation model storage 15a.

In step S11b, the linguistic feature estimation model learning part 11b learns the linguistic feature estimation model for estimating the paralinguistic information on the basis of only the linguistic features using the utterance with teacher labels stored in the utterance-with-teacher label storage 10a. The linguistic feature estimation model learning part 11b stores the learned linguistic feature estimation model in the linguistic feature estimation model storage 15b. The linguistic feature estimation model learning part 11b learns the linguistic feature estimation model as follows using the linguistic feature extracting part 111b and the model learning part 112b.

In step S111b, the linguistic feature extracting part 111b extracts the linguistic features from the utterance stored in the utterance-with-teacher label storage 10a. In extraction of the linguistic features, a word sequence acquired through a speech recognition technique or a phenome sequence acquired through a phenome recognition technique is utilized The linguistic features may be the word sequence or the phenome sequence expressed as a sequence vector, or may be a vector indicating the number of appearances of a specific word in the whole utterance. The linguistic feature extracting part 111b outputs the extracted linguistic features to the model learning part 112b.

In step S112b, the model learning part 112b learns the linguistic feature estimation model for estimating the paralinguistic information from the linguistic features on the basis of the linguistic features output by the linguistic feature extracting part 111b and the teacher labels stored in the utterance-with-teacher label storage 10a. The estimation model to be learned is similar to that learned by the model learning part 112a. The model learning part 112b stores the learned linguistic feature estimation model in the linguistic feature estimation model storage 15b.

In step S12a, the prosodic feature paralinguistic information estimating part 12a estimates the paralinguistic information based on only the prosodic features from the utterance with no teacher label stored in the utterance-with-no-teacher label storage 10b using the prosodic feature estimation model stored in the prosodic feature estimation model storage 15a. The prosodic feature paralinguistic information estimating part 12a outputs the estimation result of the paralinguistic information to the prosodic feature data selecting part 13a and the linguistic feature data selecting part 13b. The prosodic feature paralinguistic information estimating part 12a estimates the paralinguistic information as follows using the prosodic feature extracting part 121a and the paralinguistic information estimating part 122a.

In step S121a, the prosodic feature extracting part 121a extracts the prosodic features from the utterance stored in the utterance-with-no-teacher label storage 10b. An extraction method of the prosodic features is similar to that performed by the prosodic feature extracting part 111a. The prosodic feature extracting part 121a outputs the extracted prosodic features to the paralinguistic information estimating part 122a.

In step S122a, the paralinguistic information estimating part 122a inputs the prosodic features output by the prosodic feature extracting part 121a to the prosodic feature estimation model stored in the prosodic feature estimation model storage 15a to obtain confidence of the paralinguistic information based on the prosodic features. Here, as the confidence of the paralinguistic information, for example, in a case where a DNN is used as the estimation model, a posterior probability for each teacher label is used. Further, for example, in a case where SVM is used as the estimation model, a distance from an identification plane is used. The confidence indicates a “likelihood of the paralinguistic information”. For example, when a DNN is used as the estimation model, and a posterior probability of certain utterance is “interrogative: 0.8, declarative: 0.2”, interrogative confidence is 0.8, and declarative confidence is 0.2. The paralinguistic information estimating part 122a outputs the obtained confidence of the paralinguistic information based on the prosodic features to the prosodic feature data selecting part 13a and the linguistic feature data selecting part 13b.

In step S 12b, the linguistic feature paralinguistic information estimating part 12b estimates the paralinguistic information based on only the linguistic features from the utterance with no teacher label stored in the utterance-with-no-teacher label storage 10b using the linguistic feature estimation model stored in the linguistic feature estimation model storage 15b. The linguistic feature paralinguistic information estimating part 12b outputs the estimation result of the paralinguistic information to the prosodic feature data selecting part 13a and the linguistic feature data selecting part 13b. The linguistic feature paralinguistic information estimating part 12b estimates the paralinguistic information as follows using the linguistic feature extracting part 121b and the paralinguistic information estimating part 122b.

In step S121b, the linguistic feature extracting part 121b extracts the linguistic features from the utterance stored in the utterance-with-no-teacher label storage 10b. The extraction method of the linguistic features is similar to that performed by the linguistic feature extracting part 111b. The linguistic feature extracting part 121b outputs the extracted linguistic features to the paralinguistic information estimating part 122b.

In step S122b, the paralinguistic information estimating part 122b inputs the linguistic features output by the linguistic feature extracting part 121b to the linguistic feature estimation model stored in the linguistic feature estimation model storage 15b to obtain confidence of the paralinguistic information based on the linguistic features. The confidence of the paralinguistic information to be obtained is similar to that obtained at the paralinguistic information estimating part 122a. The paralinguistic information estimating part 122b outputs the obtained confidence of the paralinguistic information based on the linguistic features to the prosodic feature data selecting part 13a and the linguistic feature data selecting part 13b.

In step S13a, the prosodic feature data selecting part 13a selects self-training data for relearning the estimation model based on the prosodic features (hereinafter, referred to as “prosodic feature self-training data”) from the utterance with no teacher label stored in the utterance-with-no-teacher label storage 10b using the confidence of the paralinguistic information based on the prosodic features output by the prosodic feature paralinguistic information estimating part 12a and the confidence of the paralinguistic information based on the linguistic features output by the linguistic feature paralinguistic information estimating part 12b. Data selection is performed through threshold processing on the confidence of the paralinguistic information based on the prosodic features and the confidence of the paralinguistic information based on the linguistic features obtained for each piece of utterance. The threshold processing is the process determining whether or not each of confidence of all pieces of the paralinguistic information (interrogative, declarative) is higher than a threshold. As the threshold of the confidence, a confidence threshold regarding the prosodic features (hereinafter, referred to as a “prosodic feature confidence threshold for prosodic features”), and a confidence threshold regarding the linguistic features (hereinafter, referred to as a “linguistic feature confidence threshold for prosodic features”) are set in advance. Further, the prosodic feature confidence threshold for prosodic features are set at a lower value than that of the linguistic feature confidence threshold for prosodic features. For example, the prosodic feature confidence threshold for prosodic features is set at 0.6, and the linguistic feature confidence threshold for prosodic features is set at 0.8. The prosodic feature data selecting part 13a outputs the selected prosodic feature self-training data to the prosodic feature estimation model relearning part 14a.

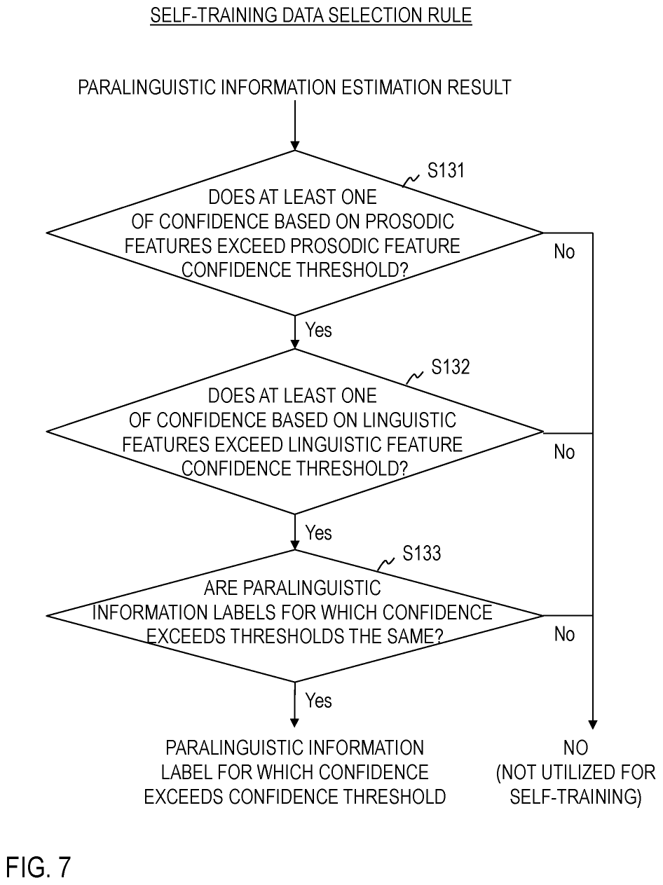

FIG. 7 illustrates a self-training data selection rule. In step S131, it is determined whether there is confidence which exceeds the prosodic feature confidence threshold among the confidence based on the prosodic features. If there is no confidence which exceeds the threshold (No), the utterance is not utilized for self-training. If there is confidence which exceeds the threshold (Yes), in step S132, it is determined whether there is confidence which exceeds the linguistic feature confidence threshold among the confidence based on the linguistic features. If there is no confidence which exceeds the threshold (No), the utterance is not utilized for self-training. If there is confidence which exceeds the threshold (Yes), in step 5133, it is determined whether a paralinguistic information label having the confidence based on the prosodic features, which exceeds the prosodic feature confidence threshold is the same as a paralinguistic information label having the confidence based on the linguistic features, which exceeds the linguistic feature confidence threshold. If the paralinguistic information labels having the confidence which exceeds the thresholds are not the same (No), the utterance is not utilized for self-training. If the paralinguistic information labels having the confidence which exceeds the thresholds are the same (Yes), the paralinguistic information is added to the utterance as a teacher label, and the utterance is selected as self-training data.

For example, the prosodic feature confidence threshold is set at 0.6, and the linguistic feature confidence threshold is set at 0.8. When confidence based on the prosodic features of certain utterance A is “interrogative: 0.3, declarative: 0.7”, and confidence based on the linguistic features of the utterance A is “interrogative: 0.1, declarative: 0.9”, the confidence based on the prosodic features for “declarative” exceeds the threshold, and the confidence based on the linguistic features for “declarative” also exceeds the threshold. Therefore, the utterance A is utilized for self-training while a teacher label is set as “declarative”. Meanwhile, when confidence based on the prosodic features of certain utterance B is “interrogative: 0.1, declarative: 0.9”, and confidence based on the linguistic features of the utterance B is “interrogative: 0.8, declarative: 0.2”, the confidence based on the prosodic features for “declarative” exceeds the threshold, and the confidence based on the linguistic features for “interrogative” also exceeds the threshold. In this case, because the paralinguistic information labels of the confidence which exceeds the thresholds are not the same, the utterance B is not utilized for self-training as utterance with no teacher label.

In step S13b, the linguistic feature data selecting part 13b selects self-training data for relearning an estimation model based on the linguistic features (hereinafter, referred to as “linguistic feature self-training data”) from the utterance with no teacher label stored in the utterance-with-no-teacher label storage 10b using the confidence of the paralinguistic information based on the prosodic features output by the prosodic feature paralinguistic information estimating part 12a and the confidence of the paralinguistic information based on the linguistic features output by the linguistic feature paralinguistic information estimating part 12b. While a data selection method is similar to that used by the prosodic feature data selecting part 13a, thresholds to be used for threshold processing are different. As the thresholds to be used by the linguistic feature data selecting part 13b, a confidence threshold regarding prosodic features (hereinafter, referred to as a “prosodic feature confidence threshold for linguistic features”) and a confidence threshold regarding linguistic features (hereinafter, referred to as a “linguistic feature confidence threshold for linguistic features”) are set in advance. Further, the linguistic feature confidence threshold for linguistic features is set at a lower value than that of the prosodic feature confidence threshold for linguistic features. For example, the prosodic feature confidence threshold for linguistic features is set at 0.8, and the linguistic feature confidence threshold for linguistic features is set at 0.6. The linguistic feature data selecting part 13b outputs the selected linguistic feature self-training data to the linguistic feature estimation model relearning part 14b.

It is assumed that a self-training data selection rule to be used by the linguistic feature data selecting part 13b has a form in which the prosodic features are replaced with the linguistic features in the self-training selection rule to be used by the prosodic feature data selecting part 13a illustrated in FIG. 7.

In step S 14a, the prosodic feature estimation model relearning part 14a relearns the prosodic feature estimation model for estimating the paralinguistic information on the basis of only the prosodic features using the prosodic feature self-training data output by the prosodic feature data selecting part 13a in a similar manner to the prosodic feature estimation model learning part 11a. The prosodic feature estimation model relearning part 14a updates the prosodic feature estimation model stored in the prosodic feature estimation model storage 15a with the relearned prosodic feature estimation model.

In step S14b, the linguistic feature estimation model relearning part 14b relearns the linguistic feature estimation model for estimating the paralinguistic information on the basis of only the linguistic features using the linguistic feature self-training data output by the linguistic feature data selecting part 13b in a similar manner to the linguistic feature estimation model learning part 11b. The linguistic feature estimation model relearning part 14b updates the linguistic feature estimation model stored in the linguistic feature estimation model storage 15b with the relearned linguistic feature estimation model.

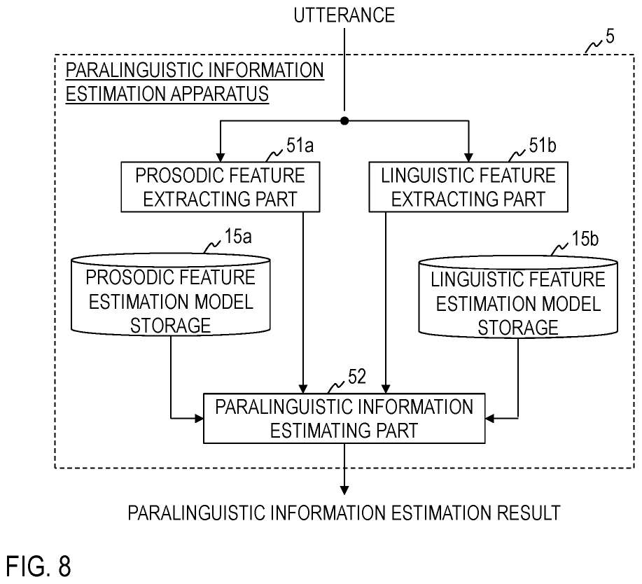

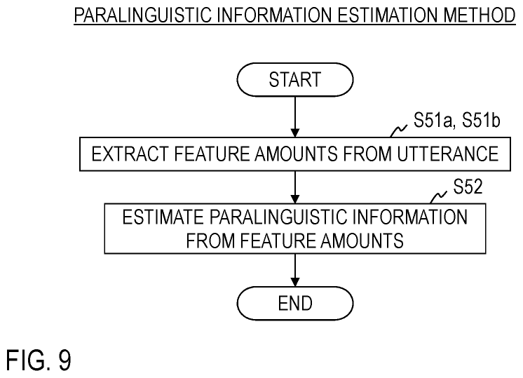

FIG. 8 is paralinguistic information estimation apparatus which estimates the paralinguistic information from input utterance using the relearned prosodic feature estimation model and the relearned linguistic feature estimation model. As illustrated in FIG. 8, this paralinguistic information estimation apparatus 5 includes a prosodic feature estimation model storage 15a, a linguistic feature estimation model storage 15b, a prosodic feature extracting part 51a, a linguistic feature extracting part 51b and a paralinguistic information estimating part 52. By this paralinguistic information estimation apparatus 5 performing processing of respective steps illustrated in FIG. 9, the paralinguistic information estimation method is realized.

In the prosodic feature estimation model storage 15a, the prosodic feature estimation model relearned by the estimation model learning apparatus 1 is stored. In the linguistic feature estimation model storage 15b, the linguistic feature estimation model relearned by the estimation model learning apparatus 1 is stored.

In step S51a, the prosodic feature extracting part 51a extracts prosodic features from utterance input to the paralinguistic information estimation apparatus 5. An extraction method of prosodic features is similar to that used by the prosodic feature extracting part 111a. The prosodic feature extracting part 51a outputs the extracted prosodic features to the paralinguistic information estimating part 52.

In step S51b, the linguistic feature extracting part 51b extracts linguistic features from utterance input to the paralinguistic information estimation apparatus 5. An extraction method of linguistic features is similar to that used by the linguistic feature extracting part 111b. The linguistic feature extracting part 51b outputs the extracted linguistic features to the paralinguistic information estimating part 52.

In step S52, the paralinguistic information estimating part 52 first inputs the prosodic features output by the prosodic feature extracting part 51a to the prosodic feature estimation model stored in the prosodic feature estimation model storage 15a to obtain confidence of the paralinguistic information based on the prosodic features. Then, the paralinguistic information estimating part 52 inputs the linguistic features output by the linguistic feature extracting part 51b to the linguistic feature estimation model stored in the linguistic feature estimation model storage 15b to obtain confidence of the paralinguistic information based on the linguistic features. Then, the paralinguistic information of the input utterance is estimated on the basis of a predetermined rule using the confidence of the paralinguistic information based on the prosodic features and the confidence of the paralinguistic information based on the linguistic features. The predetermined rule may be, for example, a rule such that, in a case where a posterior probability of “interrogative” is higher in one of the confidence of the paralinguistic information, the utterance is estimated as “interrogative”, while, in a case where a posterior probability of “declarative” is higher in both of the confidence of the paralinguistic information, the utterance is estimated as “declarative”, or, for example, as a result of a weighted sum of the posterior probability of the paralinguistic information based on the prosodic features being compared with a weighted sum of the posterior probability of the paralinguistic information based on the linguistic features, a higher weighted sum may be set as a final estimation result of the paralinguistic information.

### Second Embodiment

In a second embodiment, self-training based on data selection from two aspects is recursively performed. That is, selection of utterance which should be learned using an estimation model enhanced through self-training, and enhancement of the estimation model using the selected utterance, . . . are repeated. By repeating this loop processing, it is possible to construct the estimation model based on only the prosodic features and the estimation model based on only the linguistic features, whose estimation accuracy is further improved. Loop end determination is performed when each time of loop processing is performed, and, in a case where it is judged that the estimation model will not be improved any more, the loop processing is finished. By this means, it is possible to increase kinds of variation of utterance which should be learned while surely keeping selection of only utterance which should be learned, so that it is possible to further improve estimation accuracy of the paralinguistic information estimation model.

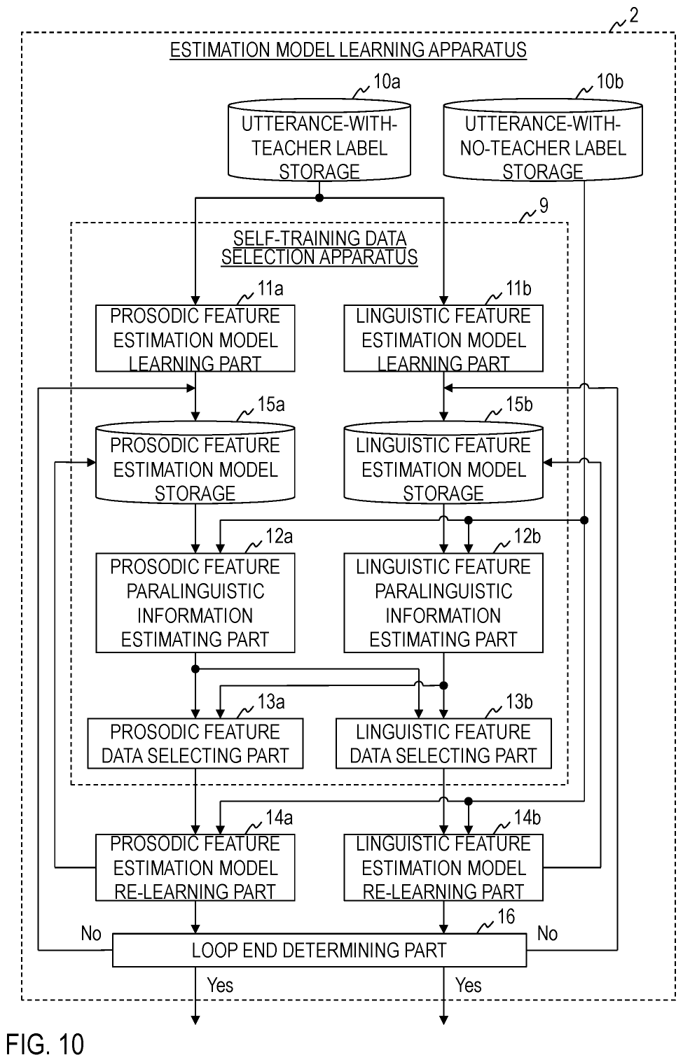

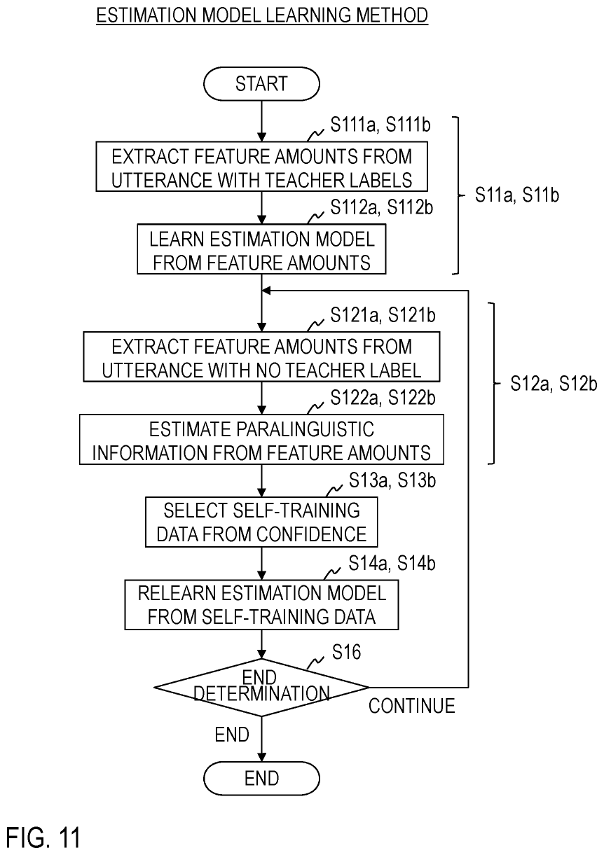

As illustrated in FIG. 10, the estimation model learning apparatus 2 of the second embodiment includes a loop end determining part 16 in addition to the respective processing parts provided at the estimation model learning apparatus 1 of the first embodiment. By this estimation model learning apparatus 2 performing processing of respective steps illustrated in FIG. 11, an estimation model learning method of the second embodiment is realized.

Concerning the estimation model learning method to be executed by the estimation model learning apparatus 2 of the second embodiment, a difference from the estimation model learning method of the first embodiment will be mainly described below with reference to FIG. 11.

In step S16, the loop end determining part 16 determines whether or not to finish the loop processing. For example, in a case where both the prosodic feature estimation model and the linguistic feature estimation model become the same estimation models before and after the loop processing (that is, the both estimation models are not improved), or in a case where the number of times of loop processing exceeds a specified number (for example, ten times), the loop processing is finished. Whether or not the estimation models become the same estimation models can be judged through comparison of parameters of the estimation models before and after the loop processing or evaluation as to whether estimation accuracy for data for evaluation is improved by a fixed degree before and after the loop processing. In a case where the loop processing is not finished, the processing returns to steps S121a, S121b, and the self-training data is selected again using the relearned estimation model. Note that an initial value of the number of times of loop processing is set at 0, and every time the loop end determining part 16 is executed once, the number of times of loop processing is incremented.

As in the first embodiment, by performing selection of utterance which should be learned and relearning of the model using the selected utterance once, estimation accuracy of the estimation model based on only the prosodic features and the estimation model based on only the linguistic features is improved. By selecting utterance which should be learned again using this estimation model with improved estimation accuracy, it is possible to detect new utterance which should be learned. By performing relearning using the new utterance which should be learned, estimation accuracy of the model is further improved.

### Third Embodiment

In a third embodiment, the prosodic feature confidence threshold or the linguistic feature confidence threshold, or both of them are changed to be lower in accordance with the number of times of loop processing in recursive self-training in the second embodiment. By this means, it is possible to utilize utterance with less estimation errors for self-training in a stage in which the number of times of loop processing is small, and model learning is not sufficiently performed, and utilize a variety of utterance for self-training in a stage in which the number of times of loop processing is increased, and model learning is performed to some extent. As a result, learning of the paralinguistic information estimation model becomes stable, so that it is possible to improve estimation accuracy of the model.

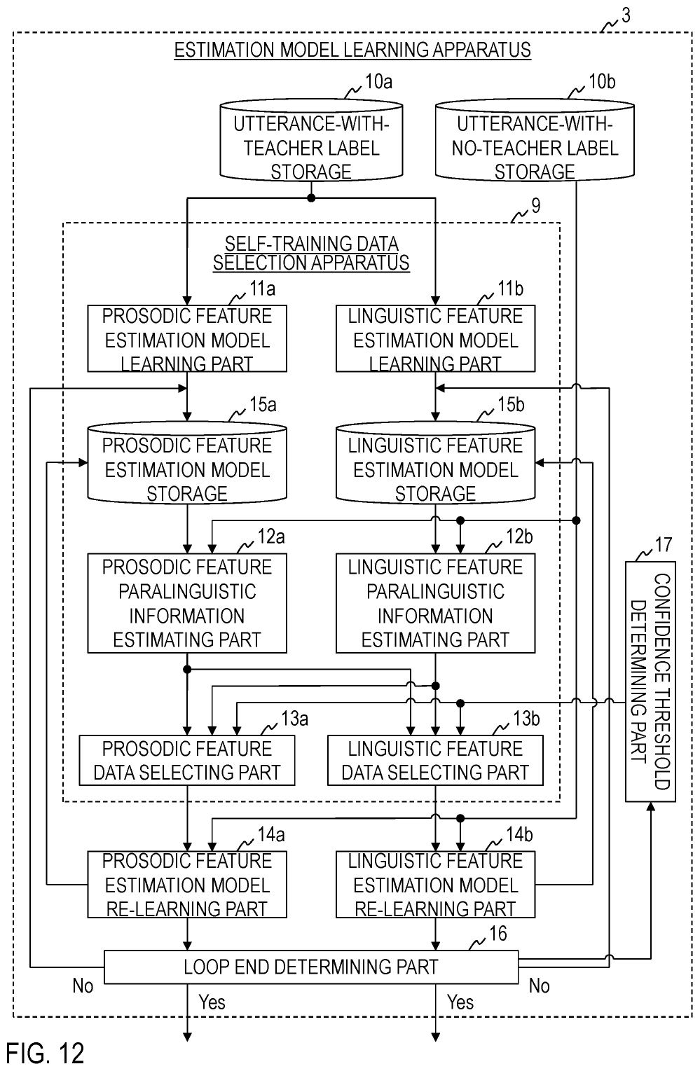

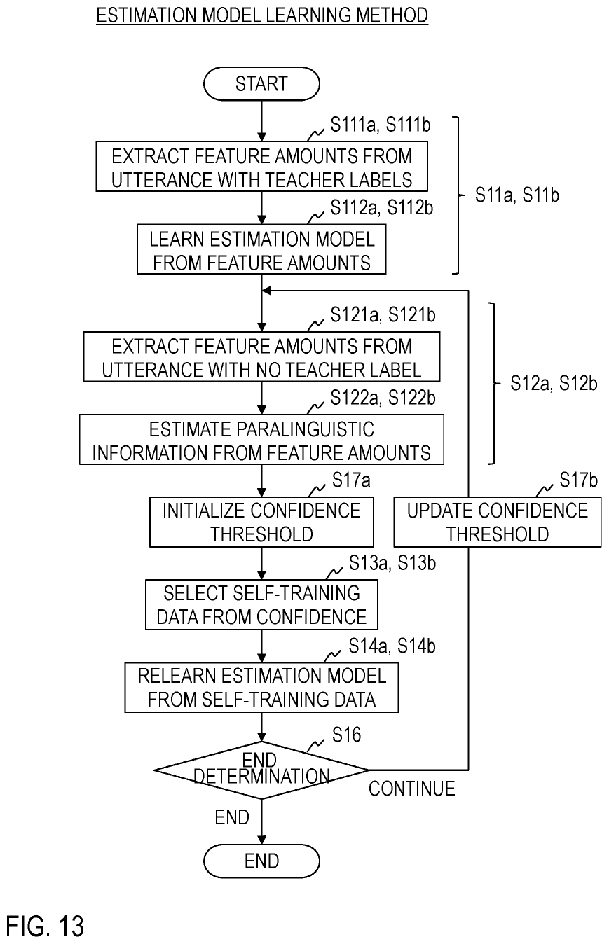

As illustrated in FIG. 12, the estimation model learning apparatus 3 of the third embodiment includes a confidence threshold determining part 17 in addition to the respective processing parts provided at the estimation model learning apparatus 2 of the second embodiment. By this estimation model learning apparatus 3 performing processing in respective steps illustrated in FIG. 13, an estimation model learning method of the third embodiment is realized.

Concerning the estimation model learning method to be executed by the estimation model learning apparatus 3 of the third embodiment, a difference from the estimation model learning method of the second embodiment will be mainly described below with reference to FIG. 13.

In step S17a, the confidence threshold determining part 17 respectively initializes the prosodic feature confidence threshold for prosodic features, the linguistic feature confidence threshold for prosodic features, the prosodic feature confidence threshold for linguistic features and the linguistic feature confidence threshold for linguistic features. It is assumed that initial values of the respective confidence thresholds are set in advance. The prosodic feature data selecting part 13a selects the prosodic feature self-training data using the prosodic feature confidence threshold for prosodic features and the linguistic feature confidence threshold for prosodic features initialized by the confidence threshold determining part 17. In a similar manner, the linguistic feature data selecting part 13b selects linguistic feature self-training data using the prosodic feature confidence threshold for linguistic features and the linguistic feature confidence threshold for linguistic features initialized by the confidence threshold determining part 17.

In step S17b, in a case where the loop end determining part 16 determines not to finish the loop processing, the confidence threshold determining part 17 respectively updates the prosodic feature confidence threshold for prosodic features, the linguistic feature confidence threshold for prosodic features, the prosodic feature confidence threshold for linguistic features and the linguistic feature confidence threshold for linguistic features in accordance with the number of times of loop processing. Updating of the confidence thresholds is based on the following formulae. Note that \hat{ } indicates power. It is assumed that a threshold attenuation coefficient is set in advance.

(Prosodic feature confidence threshold for prosodic features)=(initial value of prosodic feature confidence threshold for prosodic features)×(threshold attenuation coefficient) \hat{ } (the number of times of loop processing)

(Linguistic feature confidence threshold for prosodic features)=(initial value of linguistic feature confidence threshold for prosodic features)×(threshold attenuation coefficient) \hat{ } (the number of times of loop processing)

(Prosodic feature confidence threshold for linguistic features)=(initial value of prosodic feature confidence threshold for linguistic features)×(threshold attenuation coefficient) \hat{ } (the number of times of loop processing)

(Linguistic feature confidence threshold for linguistic features)=(initial value of linguistic feature confidence threshold for linguistic features)×(threshold attenuation coefficient) \hat{ } (the number of times of loop processing)

The prosodic feature data selecting part 13a selects the prosodic feature self-training data using the prosodic feature confidence threshold for prosodic features and the linguistic feature confidence threshold for prosodic features updated by the confidence threshold determining part 17 in the next loop processing. In a similar manner, the linguistic feature data selecting part 13b selects the linguistic feature self-training data using the prosodic feature confidence threshold for linguistic features and the linguistic feature confidence threshold for linguistic features updated by the confidence threshold determining part 17 in the next loop processing.

In the above-described respective embodiments, a configuration has been described where prosodic features and linguistic features are extracted from speech data which stores utterance of a human, and an estimation model for estimating paralinguistic information on the basis of only each type of the features is self-trained. However, the present invention is not limited to such a configuration where only two types of features are used to classify only two types of paralinguistic information, and can be applied as appropriate to a technique of performing classification into a plurality of labels using a plurality of independent feature amounts from input data.

In the present invention, prosodic features and linguistic features are used to estimate paralinguistic information. The prosodic features and the linguistic features are independent feature amounts, and paralinguistic information can be estimated to some extent using each type of feature amounts alone. For example, it is possible to completely change spoken language and tone of voice separately, and it is possible to estimate whether utterance is interrogative to some extent only with one of them alone. The present invention can be applied to combination of other feature amounts if the feature amounts are a plurality of independent feature amounts in this manner. However, it should be noted that, because independence between feature amounts is lost if one feature amount is subdivided, there is a possibility that estimation accuracy may degrade, and utterance which is erroneously estimated as utterance with high confidence may increase.

There may be three or more types of feature amounts to be used for estimation of the paralinguistic information. For example, it is also possible to employ a configuration where the estimation model for estimating the paralinguistic information on the basis of feature amounts regarding face (expression) in addition to the prosodic features and the linguistic features is learned, and utterance for which confidence of all the feature amounts exceeds confidence thresholds is selected as self-training data.

While the embodiments of the present invention have been described above, it goes without saying that a specific configuration is not limited to these embodiments, and design change, or the like, which is made as appropriate within the scope not deviating from the gist of the present invention are incorporated into the present invention. Various kinds of processing described in the embodiments are executed not only in chronological order in accordance with order of description, but also executed in parallel or individually in accordance with processing performance of apparatuses which execute the processing or as necessary.

[Program, Recording Medium]

In a case where various kinds of processing functions of the respective apparatuses described in the above-described embodiments are realized with a computer, processing content of the functions which should be provided at the respective apparatuses is described with a program. Then, by this program being executed with the computer, various kinds of processing functions at the above-described respective apparatuses are realized on the computer.

The program describing this processing content can be recorded in a computer-readable recording medium. As the computer-readable recording medium, any medium such as, for example, a magnetic recording apparatus, an optical disk, a magnetooptic recording medium and a semiconductor memory can be used.

Further, this program is distributed by, for example, a portable recording medium such as a DVD and a CD-ROM in which the program is recorded being sold, given, lent, or the like. Still further, it is also possible to employ a configuration where this program is distributed by the program being stored in a storage apparatus of a server computer and transferred from the server computer to other computers via a network.

A computer which executes such a program, for example, first, stores a program recorded in the portable recording medium or a program transferred from the server computer in the storage apparatus of the own computer once. Then, upon execution of the processing, this computer reads the program stored in the storage apparatus of the own computer and executes the processing in accordance with the read program. Further, as another execution form of this program, the computer may directly read a program from the portable recording medium and execute the processing in accordance with the program, and, further, sequentially execute the processing in accordance with the received program every time the program is transferred from the server computer to this computer. Further, it is also possible to employ a configuration where the above-described processing is executed by so-called ASP (Application Service Provider) type service which realizes processing functions only by an instruction of execution and acquisition of a result without the program being transferred from the server computer to this computer. Note that, it is assumed that the program in the present embodiment includes information which is to be used for processing by an electronic computer, and which is equivalent to a program (not a direct command to the computer, but data, or the like, having property specifying processing of the computer).

Further, while, in this embodiment, the present apparatus is constituted by a predetermined program being executed on the computer, at least part of the processing content may be realized with hardware.

1. A self-training data selection apparatus comprising:
an estimation model storage configured to store an estimation model for estimating confidence for each of predetermined labels from each of feature amounts extracted from input data, learned using a plurality of the independent feature amounts extracted from data with a teacher label;
a confidence estimating part configured to estimate confidence for each of the labels from the feature amounts extracted from data with no teacher label using the estimation model; and
a data selecting part configured to, when one feature amount selected from the feature amounts is set as a feature amount to be learned, the confidence for each label obtained from the data with no teacher label exceeds all confidence thresholds which are set in advance for each of the feature amounts for the feature amount to be learned, and labels for which confidence exceeds the confidence thresholds are the same in all feature amounts, add a label corresponding to the confidence which exceeds all the confidence thresholds to the data with no teacher label as a teacher label to select the data as self-training data of the feature amount to be learned,
wherein the confidence thresholds are set higher for a feature amount which is not to be learned than for the feature amount to be learned.

2. The self-training data selection apparatus according to claim 1,
wherein the predetermined labels are a plurality of labels regarding paralinguistic information.

3. The self-training data selection apparatus according to claim 1 or 2,
wherein the plurality of independent feature amounts are prosodic features and linguistic features extracted from utterance speech.

4. An estimation model learning apparatus comprising:
an estimation model storage configured to store an estimation model for estimating confidence for each of predetermined labels from each of feature amounts extracted from input data, learned using a plurality of the independent feature amounts extracted from data with a teacher label;
a confidence estimating part configured to estimate confidence for each of the labels from the feature amounts extracted from data with no teacher label using the estimation model;
a data selecting part configured to, when one feature amount selected from the feature amounts is set as a feature amount to be learned, the confidence for each label obtained from the data with no teacher label exceeds all confidence thresholds which are set in advance for each of the feature amounts for the feature amount to be learned, and labels for which confidence exceeds the confidence thresholds are the same in all feature amounts, add a label corresponding to the confidence which exceeds all the confidence thresholds to the data with no teacher label as a teacher label to select the data as self-training data of the feature amount to be learned; and
an estimation model relearning part configured to relearn the estimation model corresponding to the feature amount to be learned using the self-training data of the feature amount to be learned,
wherein the confidence thresholds are set higher for a feature amount which is not to be learned than for the feature amount to be learned.

5. The estimation model learning apparatus according to claim 4, further comprising:
a confidence threshold determining part configured to determine the confidence thresholds so that values of the confidence thresholds become lower in accordance with a number of times of execution of loop processing while execution of the confidence estimating part, the data selecting part and the estimation model relearning part is set as loop processing of one time.

6. A self-training data selection method comprising:
storing in an estimation model storage, an estimation model for estimating confidence for each of predetermined labels from each of feature amounts extracted from input data, learned using a plurality of the independent feature amounts extracted from data with a teacher label;
estimating confidence for each of the labels from the feature amounts extracted from data with no teacher label using the estimation model at a confidence estimating part; and
when one feature amount selected from the feature amounts is set as a feature amount to be learned, the confidence for each label obtained from the data with no teacher label exceeds all confidence thresholds which are set in advance for each of the feature amounts for the feature amount to be learned, and labels for which confidence exceeds the confidence thresholds are the same in all feature amounts, adding a label corresponding to the confidence which exceeds all the confidence thresholds to the data with no teacher label as a teacher label to select the data as self-training data of the feature amount to be learned, at a data selecting part,
wherein the confidence thresholds are set higher for a feature amount which is not to be learned than for the feature amount which is to be learned.

7. An estimation model learning method comprising:
storing in an estimation storage, an estimation model for estimating confidence for each of predetermined labels from each of feature amounts extracted from input data, learned using a plurality of the independent feature amounts extracted from data with a teacher label;
estimating confidence for each of the labels from the feature amounts extracted from data with no teacher label using the estimation model at a confidence estimating part;
when one feature amount selected from the feature amounts is set as a feature amount to be learned, the confidence for each label obtained from the data with no teacher label exceeds all confidence thresholds which are set in advance for each of the feature amounts for the feature amount to be learned, and labels for which confidence exceeds the confidence thresholds are the same in all feature amounts, adding a label corresponding to the confidence which exceeds all the confidence thresholds to the data with no teacher label as a teacher label to select the data as self-training data of the feature amount to be learned, at a data selecting part; and
relearning the estimation model corresponding to the feature amount to be learned using the self-training data of the feature amount to be learned at an estimation model relearning part,
wherein the confidence thresholds are set higher for a feature amount which is not to be learned than for the feature amount to be learned.

8. A non-transitory computer-readable recording medium on which a program recorded thereon for causing a computer to function as the self-training data selection apparatus according to claim 1 or 2.

9. A non-transitory computer-readable recording medium on which a program recorded thereon for causing a computer to function as the estimation model learning apparatus according to claim 4 or 5.
